(19) United States
(12) Patent Application Publication
(10) Pub. No.: US 2026/0098833 A1
(43) Pub. Date: Apr. 9, 2026

(54) TANDEM-TRAPPED ION MOBILITY SPECTROMETRY WITH MICROARRAY AND BIOSENSOR

(71) Applicant: The Florida State University Research Foundation, Inc., Tallahassee, FL (US)

(72) Inventors: Fanny Caroline Liu, Tallahassee, FL (US); Christian Bleiholder, Tallahassee, FL (US)

(21) Appl. No.: 19/354,380

(22) Filed: Oct. 9, 2025

Related U.S. Application Data
(60) Provisional application No. 63/705,337, filed on Oct. 9, 2024.

(51) Int. Cl. G01N 27/623; H01J 49/00

(52) U.S. Cl. CPC G01N 27/623; H01J 49/0059

(57) ABSTRACT

Disclosed is an analytical platform for profiling and functional analysis of proteomes, which can unveil new biological insights potentially useful for instigating novel therapeutic interventions. The disclosed analytical platform for proteome profiling is constructed by integrating plasmonic biosensor microarrays with tandem-ion mobility spectrometry. The disclosed analytical platform can separate, identify, and characterize highly similar proteoforms as well as low abundance proteoforms from plasma or other samples.

### CROSS REFERENCE TO RELATED APPLICATION

This application claims the benefit of priority to U.S. Provisional Application 63/705,337, filed Oct. 9, 2024, which is incorporated by reference herein in its entirety.

### BACKGROUND

The myriad of proteins present in blood plasma reflects an individual's health and disease (Ignjatovic V, et al. Mass Spectrometry-Based Plasma Proteomics: Considerations Sample Collection to Achieving Translational Data. J Proteome Res. 2019; 18(12):4085-4097; Geyer P E, et al. Revisiting biomarker discovery by plasma proteomics. Mol Syst Biol. 2017; 13(9):942). Proteins carry out the synthetic, catalytic, and regulatory functions that determine cellular processes (Aebersold R, et al. Mass-spectrometric exploration of proteome structure and function. Nature. 2016; 537(7620):347-355). A protein produced from the same gene can exist in many different variants, known as “proteoforms,” due to alterations in sequence, splice isoforms, and/or posttranslational modifications (FIG. 1) (Smith L M, et al. Proteoforms as the next proteomics currency. Science. 2018; 359(6380):1106-1107). Different proteoforms often demonstrate distinct characteristics, which might affect their cellular function (Yang X, et al. Widespread Expansion of Protein Interaction Capabilities by Alternative Splicing. Cell. 2016; 164(4):805-817). For example, distinct glycoproteoforms of IgG antibodies exhibit varying binding affinities towards immune cell receptors Fcγ, thereby triggering the protective or inhibitory immune response (Subedi G P, et al. The Structural Role of Antibody N-Glycosylation in Receptor Interactions. Structure. 2015; 23(9):1573-1583; Nimmerjahn F, et al. Fcγ receptors as regulators of immune responses. Nat Rev Immunol. 2008; 8(1):34-47; Falconer, et al. Antibody Fucosylation Lowers the FcγRIIIa/CD16a Affinity by Limiting the Conformations Sampled by the N162-Glycan. ACS Chem Biol. 2018; 13(8):2179-2189; Kao K S, et al. Synthetic nanobodies as tools to distinguish IgG Fc glycoforms. Proc Natl Acad Sci. 2022; 119(48):e2212658119). Therefore, a comprehensive study of proteoforms present in the plasma or other samples and their physiological function are pivotal in understanding the mechanisms underlying health and disease.

The vast molecular heterogeneity in proteoforms renders the characterization and quantification of the plasma proteome analytically very challenging. Existing proteoforms born from the combination of diverse posttranslational modifications offer a very large number of combinatorial possibilities. Further, plasma proteome profiling suffers from a wide dynamic range that spans over >10 orders of magnitude. Human serum albumin is detected at ˜50 mg/mL, which is 10 orders of magnitude higher than the concentration of biomarkers for inflammation and heart disease, e.g., Interleukin-6, at 5 pg/mL (Geyer P E, et al. Revisiting biomarker discovery by plasma proteomics. Mol Syst Biol. 2017; 13(9):942). From the estimated >10,000 plasma proteins, 99% of the total mass accounts for only 22 proteins. A recent study (Melani R D, et al. The Blood Proteoform Atlas: A reference map of proteoforms in human hematopoietic cells. Science. 2022; 375(6579):411-418) identified ˜30,000 proteoforms but noted that these account for a minuscule amount (3%) of all proteoforms that are expected to be present (Smith L M, et al. The Consortium for Top-Down Proteomics. The Human Proteoform Project: Defining the human proteome. Sci Adv. 2021; 7(46):eabk0734). Furthermore, roughly ˜90% of the identified proteoforms are <20 kDa, although proteins with masses up to 50 kDa were identified. These considerations highlight that plasma proteoform coverage is inadequate due to current technical limitations in detecting low-abundant proteoforms from a highly heterogeneous biological mixture.

Conventional analytical strategies for mitigating the dynamic range in plasma proteins include depleting highly abundant proteins and extensive fractionation in combination with multiplexing (Geyer P E, et al. Revisiting biomarker discovery by plasma proteomics. Mol Syst Biol. 2017; 13(9):942). These strategies routinely achieve a plasma proteome coverage of ˜1300 proteins, which is ˜13% of the estimated total protein number in plasma (Geyer P E, et al. Plasma Proteome Profiling to Assess Human Health and Disease. Cell Syst. 2016; 2(3):185-195; Geyer P E, et al. Proteomics reveals the effects of sustained weight loss on the human plasma proteome. Mol Syst Biol. 2016; 12(12):901).

More recently, magnetic bead-based chemical affinity purification has been developed by several laboratories to investigate low-level plasma proteins (Blume J E, et al. Rapid, deep and precise profiling of the plasma proteome with multi-nanoparticle protein corona. Nat Commun. 2020; 11(1):3662; Roberts D S, et al. Reproducible large-scale synthesis of surface silanized nanoparticles as an enabling nanoproteomics platform: Enrichment of the human heart phosphoproteome. Nano Res. 2019; 12(6):1473-1481). Here, paramagnetic nanoparticles coated with various surface functionalizations are used to capture subsets of plasma proteins. The captured protein subsets are then purified and digested prior to an LC-MS/MS analysis (bottom-up proteomics). The combination of magnetic bead-based affinity purification and a bottom-up proteomic approach detected up to 2000 protein groups (Id.). However, this depth of coverage is not yet sufficient to detect the complete plasma proteome, which is estimated to contain more than 10,000 proteins and >>30,000 proteoforms.

Additionally, while magnetic beads can capture distinct subsets of plasma proteins, it is unclear if they can capture/enrich specific proteoforms with similar structures and/or amino acid sequences. Further, the bottom-up proteomics approach of digesting captured proteins into peptides prior to mass spectrometry identification does not conserve the proteoform information, e.g., the locations of post-translational modifications on the same protein molecule. Finally, these approaches do not provide insights into the binding affinity and specificity of the various proteoforms.

What is thus needed are new analytical methods and devices for the analysis of proteomes in complex samples. Further methods of analysis of nucleic acids, which typically suffer the same challenges, are also needed. The methods and devices disclosed herein address these and other needs.

### SUMMARY

Disclosed herein is an analytical platform for profiling and functional analysis of proteomes, which can unveil new biological insights potentially useful for instigating novel therapeutic interventions. The disclosed analytical platform for proteome profiling is constructed by integrating plasmonic biosensor microarrays with tandem-ion mobility spectrometry. The disclosed analytical platform can separate, identify, and characterize highly similar proteoforms as well as low abundance proteoforms from plasma or other samples.

The analytical platform disclosed here combines two components: (1) peptide microarrays for separating proteoforms, and (2) Tandem-TIMS/MS for identification and structural characterization. The disclosed analytical platform can also include (3) a LSPR biosensor to characterize binding affinity. The disclosed analytical method can facilitate the identification of highly similar and/or low-abundant proteoforms of the plasma proteome. This can result in higher proteome coverage and lead to new biological insights potentially useful for developing novel therapeutic interventions.

The disclosed analytical platform can also be used to investigate how proteins and ribonucleic acids (RNAs) regulate their biological roles in the cell through their structural dynamic, in order to unveil new biological insights potentially useful for biomedical purposes. Surface chemistry techniques can be used in conjunction with TIMS/MS by (1) constructing an analytical platform by integrating plasmonic biosensor microarrays with tandem-ion mobility spectrometry, (2) using the developed platform for profiling and characterization of plasma proteoforms, (3) using the developed platform for RNA modification mapping and studying RNA-protein/ligand binding.

Additional advantages of the disclosed subject matter will be set forth in part in the description that follows and the figures, and in part will be obvious from the description or can be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying figures, which are incorporated in and constitute a part of this specification, illustrate several aspects described below.

FIG. 1 shows that proteoforms arise from alterations in sequence, splice isoforms, and post-translational modifications.

FIG. 2 shows the disclosed analytical platform for deep profiling of plasma proteoforms comprising of (1) combinatorially synthesized peptide microarrays, (2) tandem trapped ion mobility spectrometry/mass spectrometry, and (3) plasmonic biosensor.

FIG. 3 shows schematics of an orthogonal tandem-trapped ion mobility spectrometry (Tandem-TIMS) coupled to a mass spectrometry system.

FIG. 4 shows that tandem-TIMS partitions a mixture of proteoforms into subpopulations and enriches specific proteoforms; shown here for avidin glyco-proteoforms.

FIG. 5 shows that tandem-TIMS enables the determination of internal fragment ions, which is expected to increase the sequence coverage in protein top-down analysis.

FIG. 6 shows that tandem-TIMS partitions NISTmAb into subpopulations and reveals differences in their tertiary structures by collision-induced unfolding. Equivalent workflows are expected to characterize differences between proteoforms.

FIG. 7 shows structural characterization of plasma proteoforms using the disclosed microarray-tandem ion mobility/tandem mass spectrometry technology. (1) Peptide sequences that bind the target protein (here: IL-6) are generated from a combinatorial peptide microarray. (2) The obtained sequences are optimized against plasma in multiple iterations of sequence permutations. (3) Optimized peptide sequences enrich proteoforms in plasma samples even when they exist in low abundances.

FIG. 8 shows the wide dynamic range in plasma proteome: 99% of the total mass accounts for only 22 proteins. Less than 30% of plasma proteins have been identified.

FIG. 9 shows how post-transcriptional modifications alter the three-dimensional structures of RNA molecules and modulate the binding to protein or ligand. The analytical platform disclosed herein is uniquely capable of addressing this question by (1) elucidating the primary structures using native, top-down approach, (2) detecting changes in three-dimensional structures by tandem-ion mobility in combination with energy/time-resolved study, and (3) probing the binding interactions with protein or ligand by collision-induced dissociation and the integrated plasmonic biosensor.

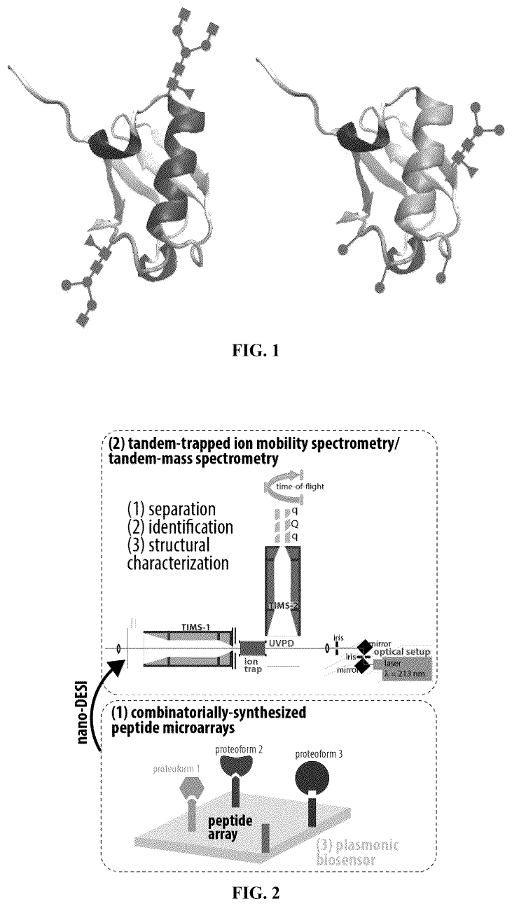

### DETAILED DESCRIPTION

The following description of the disclosure is provided as an enabling teaching of the disclosure in its best, currently known aspects. Many modifications and other aspects disclosed herein will come to mind to one skilled in the art to which the disclosed compositions and methods pertain, having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As can be apparent to those of skill in the art upon reading this disclosure, each of the individual aspects described and illustrated herein has discrete components and features that may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Further, the dates of publication provided herein can be different from the actual publication dates, which can require independent confirmation.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It can be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

The disclosed subject matter combines tandem-ion mobility spectrometry/tandem-mass spectrometry technology with combinatorially synthesized molecular microarray and plasmonic biosensor to address problems in the structural, temporal, and functional study of plasma proteome and RNAs. Plasma proteome and RNAs are notoriously known for the complexity and heterogeneity of their structures. At the same time, both proteins and RNAs are involved in essentially all cellular activities that determine an individual's health and disease state.

The disclosed subject matter addresses the challenges in the comprehensive characterization and quantification of plasma proteomes and RNAs by: (1) distinction of highly similar proteoforms or RNAs, (2) detection of low-abundant proteoforms or RNAs, and (3) comprehensive structural characterization and binding affinity of proteoforms or RNAs. The disclosed analytical platform can employ plasmonic biosensor microarray in conjunction with tandem-trapped ion mobility spectrometry/tandem-mass spectrometry methods (FIG. 2).

This approach can achieve deep separation and structural characterization of proteoforms by combining methods in surface chemistry with newly developed tandem-ion mobility spectrometry/tandem-mass spectrometry technology. For deep proteoform separation, peptide arrays generated by combinatorial peptide synthesis are utilized (Frank R, et al. SPOT synthesis. Epitope analysis with arrays of synthetic peptides prepared on cellulose membranes. Methods Mol Biol. 1996; 66:149-169; Beyer M, et al. Combinatorial Synthesis of Peptide Arrays onto a Microchip. Science. 2007; 318(5858):1888-1888; Breitling F, et al. High-density peptide arrays. Mol Biosyst. 2009; 5(3):224). This method can create thousands of peptide sequences in parallel, and through iterations, it can optimize the sequences to recognize and bind to specific proteoforms. For the identification and characterization of proteoforms, tandem-trapped ion mobility spectrometry coupled with a tandem-mass spectrometer (Tandem-TIMS/MS) can be employed (Liu F C, et al. Tandem trapped ion mobility spectrometry. Analyst. 2018; 143(10):2249-2258; Liu F C, et al. Tandem-trapped ion mobility spectrometry/mass spectrometry coupled with ultraviolet photodissociation. Rapid Commun Mass Spectrom. 2021; 35(22):e9192; Liu F C, et al. Tandem-trapped ion mobility spectrometry/mass spectrometry (t TIMS/MS): a promising analytical method for investigating heterogenous samples. The Analyst. 2022; 147(11):2317-2337; U.S. Pat. No. 10,794,861B2). Tandem-TIMS/MS features native MS and top-down analysis workflow to obtain information on the quaternary structure and subunits (Liu F C, et al. Structural Analysis of the Glycoprotein Complex Avidin by Tandem-Trapped Ion Mobility Spectrometry-Mass Spectrometry (Tandem-TIMS/MS). Anal Chem. 2020; 92(6):4459-4467; Liu F C, et al. Elucidating Structures of Protein Complexes by Collision-Induced Dissociation at Elevated Gas Pressures. J Am Soc Mass Spectrom. 2023; 34(10):2247-2258), and the primary structure of proteoforms (Id.; Liu F C, et al. Tandem Trapped Ion Mobility Spectrometry/Mass Spectrometry (tTIMS/MS) Reveals Sequence-Specific Determinants of Top-Down Protein Fragment Ion Cross Sections. Anal Chem. 2022; 94(23):8146-8155; Liu F C, et al. Top-Down Protein Analysis by Tandem-Trapped Ion Mobility Spectrometry/Mass Spectrometry (Tandem-TIMS/MS) Coupled with Ultraviolet Photodissociation (UVPD) and Parallel Accumulation/Serial Fragmentation (PASEF) MS/MS Analysis. J Am Soc Mass Spectrom. 2023; 34(10):2232-2246). To study the binding affinity and specificity of captured proteoforms, a plasmonic biosensor can be used (Himmelhaus M, et al. Self-assembly of polystyrene nano particles into patterns of random-close-packed monolayers via chemically induced adsorption. Phys Chem Chem Phys. 2002; 4(3):496-506; Chang T Y, et al. Large-scale plasmonic microarrays for label-free high-throughput screening. Lab Chip. 2011; 11(21):3596; Gao L, et al. Surface plasmon resonance biosensor for the accurate and sensitive quantification of O-GlcNAc based on cleavage by β-D-N-acetylglucosaminidase. Anal Chim Acta. 2018; 1040:90-98; Jeon H B, et al. Shape Effect on the Refractive Index Sensitivity at Localized Surface Plasmon Resonance Inflection Points of Single Gold Nanocubes with Vertices. Sci Rep. 2019; 9(1):13635; Peixoto L P F, et al. Plasmonic nanobiosensor based on Au nanorods with improved sensitivity: A comparative study for two different configurations. Anal Chim Acta. 2019; 1084:71-77) integrated as a solid support for the peptide microarray. Besides comprehensive identification and characterization of plasma proteoforms, the disclosed analytical platform can further reveal those peptide sequences that are capable of specifically targeting proteoforms. These peptide binders can be utilized in screening assays for diagnostic purposes.

In trapped ion mobility spectrometry (TIMS), ions are at first trapped along a non-uniform electric DC field (electric field gradient, EFG) by a counteracting gas flow or along a uniform electric DC field by a counteracting gas flow which has a non-uniform axial velocity profile (gas velocity gradient). The trapped ions are at first separated in space in a TIMS analyzer according to mobility and subsequently eluted from the TIMS analyzer over time according to their mobility by adjusting one of the gas velocity and the height of axial electric DC field (U.S. Pat. No. 6,630,662 B1 by Loboda; U.S. Pat. No. 7,838,826 B1 by Park). A TIMS analyzer is commonly operated in the low pressure range of 2 to 500 Pa and uses an electric RF field for radially confining the ions. Regarding the theoretical basis of TIMS, see the article “Fundamentals of Trapped Ion Mobility Spectrometry” by Michelmann et al. (J Am Soc Mass Spectrom., 2015; 26:14-24).

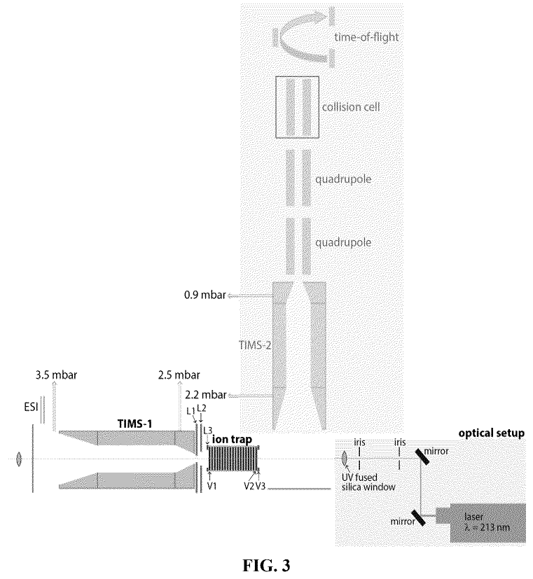

Tandem-trapped ion mobility spectrometry (Tandem-TIMS) is shown in FIG. 3. Tandem-TIMS comprises two adjacent TIMS cells incorporated with a mass spectrometry system. The Tandem-TIMS instruments feature collision-induced dissociation and UV photodissociation as ion activation methods. Various analysis workflows in Tandem-TIMS to elucidate the quaternary, tertiary, and primary structures of proteins and proteoforms from a heterogeneous mixture are discussed in Cropley T C, et al. Metastability of Protein Solution Structures in the Absence of a Solvent: Rugged Energy Landscape and Glass-like Behavior. J Am Chem Soc. 2024;jacs.3c12892. The use of a Tandem-TIMS is disclosed in U.S. Pat. No. 10,794,861, which is incorporated by reference herein for all of its teachings.

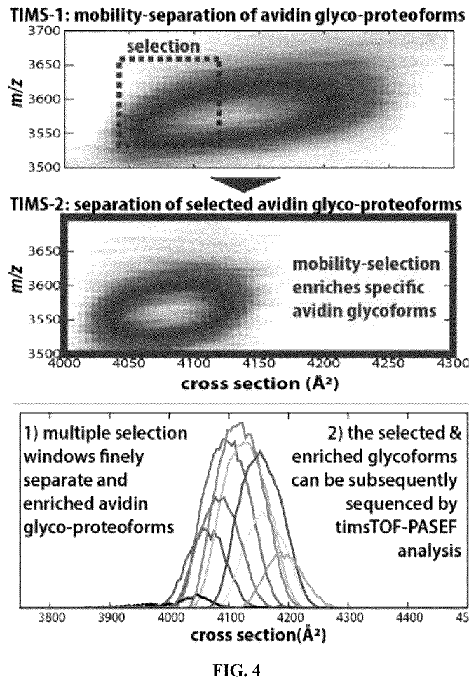

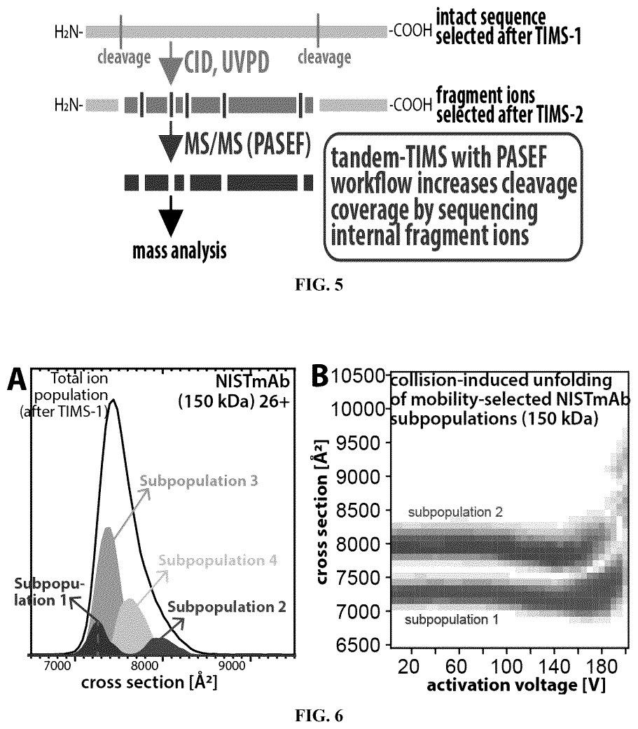

Using Tandem-TIMS's ability to select ions with specific mobility, the structural heterogeneity of native proteins, protein complexes, and a monoclonal antibody have been investigated (Liu F C, et al. Structural Heterogeneity of the Humanised IgGk NIST Monoclonal Antibody Probed by Tandem-Trapped Ion Mobility Spectrometry and Mobility-Resolved Collision-induced Unfolding. 2024). There, the results show that native glycoproteins such as avidin and the monoclonal antibody NISTmAb comprise many distinct conformations and glyco-proteoforms (FIGS. 4 and 6). Further, the mobility selection workflow in Tandem-TIMS separates unresolved conformations and glycoforms, which can subsequently be identified and structurally characterized by IMS/MS analysis. This ability to fractionate a mixture of proteoforms in TIMS-1 in combination with separation by peptide microarrays is described herein and can allow the deep separation and distinction of proteoforms with highly similar structures.

Native-like conformations of proteins and protein complexes can be retained in the gas phase during Tandem-TIMS measurements by employing soft-tuned instrumental settings (Liu F C, et al. On the structural denaturation of biological analytes in trapped ion mobility spectrometry-mass spectrometry. Analyst. 2016; 141(12):3722-3730; Bleiholder C, et al. Comment on Effective Temperature and Structural Rearrangement in Trapped Ion Mobility Spectrometry. Anal Chem. 2020; 92(24):16329-16333). These results enable the study of three-dimensional structures of proteins and protein complexes in the gas phase. Elevated pressure collision-induced dissociation has been used as a method to study subunits of protein complexes that reflect the protein assembly pathway. These studies demonstrate the capability of Tandem-TIMS to probe the quaternary arrangement and the structures of subunits in protein complexes. The results revealed that the cross-sections of top-down protein fragment ions can be utilized as sequence-specific determinants. Further, an MS/MS/MS-based top-down analysis workflow combining collision-induced dissociation and UV photodissociation in Tandem-TIMS, including the computational tools to reliably assign internal fragment ions generated by top-down analysis of native, intact proteins can be used. As depicted in FIG. 5, this approach can increase the sequence coverage of proteoforms with a mass larger than 30 kDa by sequencing internal fragment ions, which is still challenging for conventional top-down proteomics approaches.

In a specific aspect of the disclosed subject matter, the method for analyzing ions comprises the steps of providing ions from an ion source to a first trapped-ion mobility spectrometry analyzer, wherein the ion source is a peptide or RNA microarray; separating the ions according to mobility in the first trapped-ion mobility spectrometry analyzer, selecting precursor ions of at least one limited mobility range, fragmenting the selected precursor ions into fragment ions, trapping the fragment ions in a second trapped-ion mobility spectrometry analyzer, separating the fragment ions according to mobility in the second trapped-ion mobility spectrometry analyzer, and detecting the separated fragment ions, wherein the second trapped-ion mobility spectrometry analyzer is a trapped ion mobility spectrometry (TIMS) analyzer. The mobility of the fragment ions can be determined from detected ion signals of the separated fragment ions.

The steps of separating in the first trapped-ion mobility spectrometry analyzer, selecting and fragmenting can be repeated while the second trapped-ion mobility spectrometry analyzer is operated to accumulate the repeatedly fragmented ions prior to separating them according to mobility.

The ions can be temporally separated according to mobility in the first trapped-ion mobility spectrometry analyzer, and then ions of one or more limited mobility ranges are selected by adjusting the transmission of an ion gate. In particular two or more disjointed mobility ranges can be selected. In a preferred embodiment, the ion gate can comprise at least two annular electrodes, and the transmission of the ion gate is adjusted by applying attracting electric DC potentials to the at least two annular electrodes during the selection interval and by applying repelling electric DC potentials to the at least two annular electrodes outside the selection interval.

The ions can also be spatially separated according to mobility in the first trapped-ion mobility spectrometry analyzer if the first trapped-ion mobility spectrometry analyzer is a trapped ion mobility spectrometry (TIMS) analyzer. The ions are trapped along an electric DC field gradient or along a gas velocity gradient of the first TIMS analyzer and then the strength of the electric DC field or the gas velocity can be adjusted such that only ions of a limited mobility range can leave the first TIMS analyzer towards the second TIMS analyzer while unselected ions stay trapped in the TIMS analyzer. Otherwise, a subset of the ions trapped inside the first TIMS analyzer can selectively be reacted or activated at specific axial positions to change mobility, for example by multiple photon absorption or by collision induced activation in dipolar or rotational acting electric AC fields, such that only the activated or reacted ions can leave the first TIMS analyzer towards the second TIMS analyzer, in particular without an adjustment of trapping parameters of the first TIMS analyzer. The energy introduced into the activated ions can be varied in order to provide selected ions of different conformations for the fragmentation step. Preferably, the first TIMS analyzer comprises an electric DC field barrier and a counteracting gas flow which is directed downstream towards an ion detector, and the ions are pushed by the gas flow against a rising edge of the electric DC barrier where the ions of a limited mobility range are preferably trapped close to the apex of the rising edge.

The at least one mobility range can substantially correspond to the smallest mobility range that can be resolved by the first trapped-ion mobility spectrometry analyzer. However, it can also be greater or smaller than the resolvable mobility range of the first trapped-ion mobility spectrometry analyzer. The limited mobility range can correspond to the mobility spread of a single ion species or a specific conformation of an ion species, but also be less than that.

The ions can for example be generated by electrospray ionization at ambient or sub-ambient pressure, matrix-assisted laser desorption/ionization, or chemical ionization.

The selected ions can be fragmented between the first and the second trapped-ion mobility spectrometry analyzer or inside the second trapped-ion mobility spectrometry analyzer. The ions can be fragmented by one of collision induced dissociation (CID), surface induced dissociation (SID), photo-dissociation (PD), electron capture dissociation (ECD), electron transfer dissociation (ETD), collisional activation after electron transfer dissociation (ETcD), activation concurrent with electron transfer dissociation (AI-ETD) and fragmentation by reactions with highly excited or radical neutral particles. The photo-dissociation preferably comprises infrared multiple photon-dissociation (IRMPD) and ultraviolet photo-dissociation (UVPD). The selected ions can additionally be activated prior to fragmentation, and the fragment ions can all or selectively be activated during trapping, for example by multiple photon absorption or by collision induced activation in dipolar or rotational acting electric AC fields. The activation energy introduced into the selected ions or fragment ions can be varied in order to determine the mobility of the fragment ions as a function of activation energy.

The fragment ions are preferably detected in a mass analyzer located downstream of the second trapped-ion mobility spectrometry analyzer. The mass analyzer can be one of a quadrupole mass filter, a time-of-flight mass analyzer, a time-of-flight mass analyzer with orthogonal ion injection, a RF ion trap, a DC ion trap (like an orbitrap or cassini-trap) and an ion-cyclotron-resonance trap. The fragment ions can further be analyzed by acquiring fragment mass spectra of them.

Prior to the first mobility separation, the ions can be filtered according to mass in a mass filter located upstream of the first trapped-ion mobility spectrometry analyzer. After selection and prior to fragmentation, the selected ions can by filtered according to mass.

The selected ions can be trapped and fragmented in the second trapped-ion mobility spectrometry analyzer. The trapping time of the selected ions prior to fragmentation can be varied in subsequent measurements in order to determine the mobility of fragment ions as a function of time, particularly if the selected ions have been activated prior to the fragmentation. In the same way, the trapping time of the fragment ions prior to their separation according to mobility can be varied. The time-resolved determination of mobility can give insight into the temporal change of conformations and thus structural information of the selected ions. The trapping time prior to or after fragmentation as well as duration of the fragmentation can be longer than 0.1 ms, in particular longer than 1 ms, more particularly longer than 10 ms.

In a first embodiment, selected ions are fragmented by collision induced dissociation which results from accelerating the selected ions in or into a gas filled region between the first and the second trapped-ion mobility spectrometry analyzer by applying electric DC potentials to at least two annular electrodes which are located between the first and the second trapped-ion mobility spectrometry analyzer.

The electric field strength between the at least two annular electrodes is preferably higher than 50 V/cm, in particular higher than 100 V/cm, more particularly up to 1000 V/cm. The potential difference between the at least two annular electrodes is preferably more than 50, 100, 200 or 500 Volts.

The collision gas in the gas filled region can be substantially equal to the buffer gas used in one of the trapped-ion mobility spectrometry analyzers and preferably comprises at least partly a gas component having an atomic mass of more than 28 Da. The collision gas in the gas filled region can also be a mixture of buffer gas used in one of the trapped-ion mobility spectrometry analyzers and a gas component which is additionally introduced from a gas supply into the gas filled region and preferably has an atomic mass of more than 28 Da. The gas component is preferably one of argon, carbon dioxide and sulfur hexafluoride. The pressure of the collision gas is between 1 Pa and 10,000 Pa, in particular between 10 Pa and 1000 Pa, more particular between 100 Pa and 500 Pa.

In a second embodiment, the second trapped-ion mobility spectrometry analyzer (TIMS analyzer) comprises an electric DC field barrier with a rising edge and a counteracting gas flow. The selected ions are pushed by the gas flow, which is directed downstream towards an ion detector, against the rising edge and trapped at the rising edge. Photons are introduced at a location of the rising edge where the selected ions are trapped inside the second trapped-ion mobility spectrometry analyzer for inducing photo-dissociation of the selected ions. The selected ions can also be fragmented at their trapping position by locally generating electric AC fields which accelerate the selected ions in a radial and/or axial direction for inducing collisional induced dissociation.

In a third embodiment, the second trapped-ion mobility spectrometry analyzer (TIMS analyzer) comprises an electric DC field barrier with a rising edge and a counteracting gas flow. The selected ions are pushed by the gas flow, which is directed downstream towards an ion detector, against the rising edge and trapped at the rising edge. Negatively charged ETD reactant ions are transferred to the front part of the rising edge and pass through the rising edge where they react with the selected ions and induce electron transfer dissociation.

In a fourth embodiment, the second trapped-ion mobility spectrometry analyzer (TIMS analyzer) comprises an electric DC field barrier with a rising edge and a counteracting gas flow. The selected ions are pushed by the gas flow, which is directed downstream towards an ion detector, against the rising edge and trapped at the rising edge. Highly excited or radical neutral particles are transferred to the front part of the rising edge and pass through the rising edge where they react with the selected ions and induce fragmentation.

In a fifth embodiment, the selected ions are activated prior to fragmentation, e.g. by collision induced activation, single photon absorption or multiple photon absorption. Preferably, the activation energy introduced into the selected ions is varied and the mobility of the fragment ions is determined as a function of activation energy. Optionally, the mobility of the fragment ions can be measured as a function of trapping time. The measured distribution of mobility of the fragment ions can in particular be used to determine structural information of the selected ions, in particular of selected macromolecular ions.

The analyzed ions are preferably ions of macromolecules with an atomic mass higher than 10,000 Da, in particular higher than 50,000, more particularly higher than 100,000 Da. The selected ions can for example be ions of biomolecules, in particular of proteins or nucleic acids (RNA, DNA). In particular, the analyzed ions can be ions of non-covalently bound complexes wherein at least one of the binding partners is a macromolecule.

Further, the disclosed analytical platform provides a method for analyzing ions comprising the steps of providing ions from an ion source to a first trapped-ion mobility spectrometry analyzer, wherein the ion source is a peptide or RNA microarray, separating the ions according to mobility in the first trapped-ion mobility spectrometry analyzer, selecting ions of at least one limited mobility range, activating or reacting the selected ions, trapping the activated or reacted ions in a second trapped-ion mobility spectrometry analyzer, separating the trapped ions according to mobility in the second trapped-ion mobility spectrometry analyzer, and detecting the separated ions wherein the second trapped-ion mobility spectrometry analyzer is a trapped ion mobility spectrometry (TIMS) analyzer. The mobility of the activated or reacted ions can be determined from detected ion signals of the separated fragment ions.

The selected ions can be activated or reacted between the first and the second trapped-ion mobility spectrometry analyzer or inside the second trapped-ion mobility spectrometry analyzer while they are trapped. The activation energy introduced into the selected ions can be varied in subsequent measurements in order to determine the mobility of the activated ions as a function of activation energy.

If the first trapped-ion mobility spectrometry analyzer is a trapped ion mobility spectrometry (TIMS) analyzer, the ions can be trapped and spatially separated according to mobility in the first trapped-ion mobility spectrometry analyzer. A subset of the ions trapped inside the first TIMS analyzer can selectively be reacted or activated at specific axial positions to change their mobility, for example by multiple photon absorption or by collision induced activation in dipolar or rotational acting electric AC fields, such that only the activated or reacted ions can leave the first TIMS analyzer towards the second TIMS analyzer.

The ions can be temporally separated according to mobility in the first trapped-ion mobility spectrometry analyzer and then ions of the at least one limited mobility range are selected by adjusting the transmission of an ion gate, for example a Tyndall-gate or a Bradbury-Nielson gate. If the first trapped-ion mobility spectrometry analyzer is a trapped ion mobility spectrometry (TIMS) analyzer, ions can also be spatially separated according to mobility in the first trapped-ion mobility spectrometry analyzer and then only the ions of a limited mobility range are released from the first trapped-ion mobility spectrometry analyzer by an adjustment of a trapping parameter of the first TIMS analyzer.

The selected ions can for example be reacted by hydrogen-deuterium exchange reaction. The selected ions can be activated by being accelerated in or into a gas filled region or by radiative heating, for example by absorbing multiple infrared photons provided by an infrared laser or infrared laser diode.

The trapping time of the activated or reacted ions prior to their separation according to mobility can be varied in subsequent measurements in order to determine the mobility of activated or reacted ions as a function of time. The time-resolved determination of mobility can give insight into the temporal change of conformations and thus structural information of the selected ions. The trapping time prior the second mobility separation as well as duration of the activation or reaction can be longer than 0.1 ms, in particular longer than 1 ms, more particularly longer than 10 ms.

The analyzed ions are preferably ions of macromolecules with an atomic mass higher than 10,000 Da, in particular higher than 50,000, more particularly higher than 100,000 Da. The selected ions can for example be ions of biomolecules, in particular of proteins. In particular, the analyzed ions can be ions of non-covalently bound complexes wherein at least one of the binding partners is a macromolecule.

In a third aspect, the invention provides an ion mobility mass spectrometer comprising a peptide or RNA microarray as an ion source, a first trapped-ion mobility spectrometry analyzer, a second trapped-ion mobility spectrometry analyzer located downstream of the first trapped-ion mobility spectrometry analyzer, for example in an orthogonal orientation, a fragmentation or activation cell which is located between the first and the second trapped-ion mobility spectrometry analyzer or is part of the second trapped-ion mobility spectrometry analyzer and an ion detector wherein the second trapped-ion mobility spectrometry analyzer is a trapped ion mobility spectrometry (TIMS) analyzer.

The ion source can comprise means for electrospray ionization at atmospheric pressure or sub-ambient pressure, matrix-assisted laser desorption/ionization, or chemical ionization. In particular the ion source uses nano-desorption electrospray ionization.

The first mobility analyzer is preferably a trapped ion mobility spectrometry (TIMS) analyzer. Both TIMS analyzers can comprise the same gas composition or different gas compositions, in particular they can be decoupled with regard to the gas flows. More preferably, the first trapped-ion mobility spectrometry analyzer is a TIMS analyzer and comprises an electric DC field barrier with a rising edge and a gas flow which is directed downstream towards the second trapped-ion mobility spectrometry analyzer. The first mobility analyzer can alternatively be a drift type trapped-ion mobility spectrometry analyzer.

The ion mobility spectrometer can further comprise an ion gate located between the first and the second trapped-ion mobility spectrometry analyzer and a DC generator connected to the ion gate for supplying transient electric DC potentials to the ion gate. The ion gate can be one of an ion-optical einzel lens, a Tyndall gate and a Bradbury-Nielsen gate. The ion gate preferably comprises at least two annular electrodes, and the DC generator is configured to supply attracting electric DC (first state) and repelling electric DC (second state) potentials to the at least two annular electrodes.

The fragmentation cell can comprise means for collision induced dissociation (CID), surface induced dissociation (SID), photo-dissociation (PD), infrared multiple photo-dissociation (IRMPD), ultraviolet photo-dissociation (UVPD), electron capture dissociation (ECD), electron transfer dissociation (ETD), collisional activation after electron transfer dissociation (EThcD), activation concurrent with electron transfer dissociation (AI-ETD) or fragmentation by reactions with highly excited or radical neutrals. The activation cell can comprise means for radiative heating, for example an infrared laser or an infrared laser diode, or means for generating dipolar or rotational acting electric AC fields.

In a first embodiment, the fragmentation cell comprises at least two annular electrodes, which are supplied with accelerating electric DC potentials, and a gas filled region which is located between or downstream of the at least two annular electrodes. The electric field strength between the at least two annular electrodes is preferably higher than 50 V/cm, in particular higher than 100 V/cm, more particularly up to 1000 V/cm. The potential difference between the at least two annular electrodes is preferably more than 50 V, in particular more than 200 V, more particular more than 500 V.

The gas filled region can substantially comprise buffer gas used in one of the trapped-ion mobility spectrometry analyzers wherein the buffer gas comprises at least partly a gas component having an atomic mass of more than 28 Da. The fragmentation cell can further comprise a gas supply connected to the gas filled region for providing an additional gas component to buffer gas used in one of the trapped-ion mobility spectrometry analyzers wherein the provided gas component has an atomic mass of more than 28 Da. The gas component can for example be argon, carbon dioxide or sulfur hexafluoride. The pressure of the collision gas in the gas filled region is preferably between 1 Pa and 10,000 Pa, in particular 10 Pa and 1000 Pa, more particular between 100 Pa and 500 Pa.

In a second embodiment, the second trapped-ion mobility spectrometry analyzer comprises an electric DC field barrier with a rising edge and a gas flow, which is counteracting the electric DC field along the rising edge and is directed downstream. The fragmentation cell as well as the activation cell can comprise an infrared light source, in particular a laser or a laser diode, and an optical element for focusing the emitted light along the axis or onto one or more specific positions inside the trapping region of the second trapped-ion mobility spectrometry analyzer.

In a third embodiment, the fragmentation cell comprises a second ion source configured to generate negative reactant ions for electron transfer dissociation (ETD) and an ion guide with an inlet at the second ion source and outlet at the second trapped-ion mobility spectrometry analyzer. The second trapped-ion mobility spectrometry analyzer comprises an electric DC field barrier with a rising edge and a gas flow, which is counteracting the electric DC field and is directed downstream. The outlet of the ion guide between the second ion source and the second trapped-ion mobility spectrometry analyzer is located upstream or near the front part of the rising edge.

In a fourth embodiment, the fragmentation cell comprises a source of highly excited or radical neutral particles suitable to induce fragmentation of precursor ions and a feed for supplying the highly excited or radical neutral particles to the fragmentation cell. The second trapped-ion mobility spectrometry analyzer preferably comprises an electric DC field barrier with a rising edge and a gas flow, which is counteracting the electric DC field along the rising edge and is directed downstream. The feed connects the source of the highly excited or radical neutral particles to a region of the second trapped-ion mobility spectrometry analyzer which is upstream or near the front of the rising edge.

The ion detector can be a faraday ion detector or an ion detector with a secondary electron multiplier or an inductive ion detector. Preferably the ion detector is a mass analyzer, in particular one of a quadrupole mass filter, time-of-flight mass analyzer, a time-of-flight mass analyzer with orthogonal ion injection, a RF ion trap, a DC ion trap (like an orbitrap or cassini-trap) and ion-cyclotron-resonance trap. The ion mobility spectrometer can further comprise a second fragmentation cell between the second trapped-ion mobility spectrometry analyzer and the mass analyzer.

The ion mobility spectrometer can further comprise a mass filter between the ion source and the first trapped-ion mobility spectrometry analyzer or between the first trapped-ion mobility spectrometry analyzer and the fragmentation cell. The mass filter can be a band-pass mass filter, like a quadrupole mass filter, a low-pass filter or a high-pass filter, like a Loeb-Eiber mass filter.

To resolve highly similar proteoforms, high-density biomolecular microarrays featuring thousands of peptide spots, where each spot contains peptides with a specific sequence. Through multiple iterations, the sequence of the peptide binders to target highly specific proteoforms can be optimized. Distinct proteoforms are bound to specific peptide binders and, thus, are spatially resolved on the array surface. The spatial resolution of various proteoforms can be retained during ionization and transfer to Tandem-TIMS by Nano-DESI. Further separation of highly similar proteoforms can be conducted in Tandem-TIMS utilizing mobility analysis in the first TIMS, allowing the distinction of proteoforms by differences in their ion mobilities. Highly similar proteoforms that are not base-line resolved by mobility analysis in TIMS-1 can still be fractionated by mobility-selection following elution from TIMS-1 (FIGS. 4 and 6). This workflow is able to isolate unresolved conformations of native glycoprotein complexes.

Further, permutated peptide arrays enable the optimization of peptide sequences. This approach can facilitate the discovery of peptide binders targeting specific proteoforms, enabling the enrichment of specific proteoforms on the array surface. Combining the enrichment strategy by peptide microarrays and selecting low-abundant subpopulations in Tandem-TIMS can enable the profiling of low-abundant proteoforms.

Combinatorial peptide synthesis is used to generate high-density peptide microarrays comprising thousands of potential binders, each capable of recognizing and capturing a specific target molecule, such as a distinct proteoform. Through multiple iterations, the sequence of the peptides on the array can be optimized to generate peptide binders with high affinity and specificity toward distinct proteoforms. This can enable the separation of proteoforms with similar/almost identical structures and sequences, leading to a (theoretically) unlimited resolving power regarding proteoform separation. Another significant advantage of using this technology is the spatial separation of captured proteoforms on the array surface. Tandem-TIMS coupled with a mass spectrometry system is used to characterize the quaternary, tertiary, and primary structures of proteoforms. The peptide microarray integrated with the Tandem-TIMS instrument can use nano-desorption electrospray ionization (Nano-DESI). Nano-DESI has the advantages of retaining the spatial information of the peptides on the microarray and preserving the native structures of proteins/proteoforms during transfer to the gas phase (Jiang L X, et al. Nanospray Desorption Electrospray Ionization (Nano-DESI) Mass Spectrometry Imaging with High Ion Mobility Resolution. J Am Soc Mass Spectrom. 2023 Aug. 2; 34(8):1798-1804. Hale O J, Cooper H J. Native Mass Spectrometry Imaging of Proteins and Protein Complexes by Nano-DESI. Anal Chem. 2021; 93(10):4619-4627; Daniels L B. Pretenders and Contenders: Inflammation, C-Reactive Protein, and Interleukin-6. J Am Heart Assoc. 2017; 6(10):e007490). (3) A localized surface plasmon resonance (LSPR) biosensor can be used with the combinatorially synthesized molecular microarrays. Using the plasmonic biosensor, the binding affinity and specificity of distinct proteoforms captured on the array surface can be evaluated.

Optical biosensors can be integrated with peptide microarrays for label-free detection of antibody-antigen binding (Liu F C. Development of LSPR-based optical biosensors for the label-free detection of biomolecular interactions in high-density peptide arrays. Heidelberg University; 2011.). Optical sensors are fabricated based on localized plasmon resonance spectroscopy (LSPR) and whispering gallery modes (WGM) phenomena and demonstrated their use for detecting biomolecules (Id.; Weller A, et al. Whispering gallery mode biosensors in the low-Q limit. Appl Phys B. 2008; 90(3-4):561-567). Furthermore, peptide microarrays can be generated using particle-based combinatorial peptide synthesis (Loeffler F F, et al. Printing Peptide Arrays with a Complementary Metal Oxide Semiconductor Chip. Fundam Appl New Bioprod Syst. 2013. p. 1-23). This method yields thousands of peptide sequences that can potentially be used as molecular binders for specific proteoforms.

Microarrays can be applied to separate distinct proteoforms from a complex biological mixture and using LSPR biosensors to characterize the binding affinity of various proteoforms toward a ligand or other proteins/proteoforms.

Peptide microarrays can be prepared in a number of ways. For example, in light-directed in-situ solid-phase peptide synthesis (photolithographic synthesis) a slide/surface is coated with linker molecules bearing a photoremovable protecting group. A defined pattern of surface deprotection is produced by exposing selected locations to light through a mask or a maskless DMD (digital micromirror device). After exposure those sites are free to couple with an activated, protected amino-acid monomer. Iterating deprotection and coupling builds different peptide sequences at different spots in parallel. A similar process can be used to prepare nucleic acid oligomer arrays.

“Spotting” of pre-synthesized peptides (contact/non-contact microarray printing) can also be used. Here, pre-synthesize peptides (solid-phase batch synthesis) are printed onto functionalized glass (e.g., epoxy/aldehyde/NHS) with robotic spotters to create microarrays. Density is limited compared with in-situ photolithography but is widely used in industry and research (commercial peptide arrays often use this for flexible custom arrays). Similarly, in SPOT synthesis solid phase peptide synthesis (SPPS) reagents are delivered by pipetting (or in microreactors) to discrete spots where the peptide grows. This is commonly performed on cellulose membranes (SPOT) or other supports for lower-to-medium density arrays. The method uses standard SPPS coupling reagents and protecting groups (Boc or Fmoc approaches adapted for array formats).

Combinatorial Laser-Induced Forward Transfer (cLIFT)/particle-based printing is another method used to create peptide microarrays. In this approach lasers are used to transfer peptide-containing material/particles to deposit peptide precursors at very high density without direct photochemistry on the substrate. This is an alternative to direct photolithography and can achieve very high spot densities.

Other methods include combinatorial peptide synthesis on a microarray where many different peptide sequences are synthesized in parallel on a small, solid surface (like a glass slide, silicon wafer, or membrane). Each small region (spot, pixel, or feature) on the surface carries a unique peptide sequence. This method produces a large library—hundreds to millions—of defined peptides for binding studies, epitope mapping, enzyme profiling, or drug discovery. This is achieved by solid-phase peptide synthesis (SPPS) principles combined with spatial control, where each region is exposed only to the reagents needed for the sequence it's meant to contain.

In some examples, the microarray is a plasmonic peptide microarray where the peptide microarray is coupled to a plasmonic sensor. The plasmonic microarray is illuminated with light and the plasmon resonance is detected. The plasmonic microarray can detect surface plasmon resonance by measuring change in reflected light angle or intensity due to refractive index shift. Alternatively, the plasmonic microarray can detect localized surface plasmon resonance by using nanostructured metal surfaces (nanoparticles, nanoholes) where local electron oscillations are confined. In some examples, the plasmonic microarray is prepared by synthesizing a peptide microarray on a plasmonic surface like gold or a nanostructured gold or silver. Such surfaces can be functionalized with a self-assembled monolayer (SAM) like an alkanethiols terminated with carboxyl or NHS groups that allows covalent attachment of peptides or linkers.

Comprehensive structural characterization in plasma proteomes and RNAs present similar challenges: (1) isolation/distinction of highly similar species from a complex, heterogeneous sample, (2) detection of low-abundant species, (3) accurate identification of the chemical composition and sequence, (3) characterization and localization of post-transcriptional modifications, and (4) characterization of higher-order structures including ligand binding sites and affinity. To address these challenges, combinatorially synthesized molecular microarray and plasmonic biosensor can be used with tandem-ion mobility spectrometry/tandem-mass spectrometry technology to construct an analytical platform (FIG. 2).

Complex and heterogeneous biomolecular samples, such as plasma proteome and ribonucleic acids, can be investigated. The combinatorially synthesized molecular array can be used to reduce the sample complexity by enabling separation and enrichment of specific/low-abundant species. Tandem-TIMS can be employed to elucidate the quaternary, tertiary, and primary structures of isolated proteoforms or RNA molecules. Finally, a surface plasmon resonance-based biosensor integrated with the microarray can be used to analyze ligand binding affinity/specificity. The disclosed analytical platform can further reveal molecular sequences on the array capable of targeting proteoforms or RNA species with high specificity, which can potentially be applied in screening assays for diagnostic purposes.

The disclosed methods, in other exemplary aspects, can be used to determine binding affinity and specificity between two or more molecules, determine relative strength of subunit interactions in protein complexes, and RNA modification mapping.

### EXAMPLES

To further illustrate the principles of the present disclosure, the following examples are put forth so as to provide those of ordinary skill in the art with a complete disclosure and description of how the compositions, articles, and methods claimed herein are made and evaluated. They are intended to be purely exemplary of the invention and are not intended to limit the scope of what the inventors regard as their disclosure. There are numerous variations and combinations of process conditions that can be used to optimize product quality and performance. Only reasonable and routine experimentation can be required to optimize such process conditions.

### Example 1: Separation and Identification of Highly Similar Proteoforms in Saccharomyces cerevisiae (Yeast) Proteome

The yeast proteome is a good model system because it has been extensively characterized by various methods, such as mass spectrometry-based methods, GFP microscopy, and immunoblotting (Michaelis A C, et al. The social and structural architecture of the yeast protein interactome. Nature. 2023; 624(7990):192-200; Thakur S S, et al. Deep and Highly Sensitive Proteome Coverage by LC-MS/MS Without Prefractionation. Mol Cell Proteomics. 2011; 10(8):M110.003699; De Godoy L M F, et al. Comprehensive mass-spectrometry-based proteome quantification of haploid versus diploid yeast. Nature. 2008; 455(7217):1251-1254; Shortreed M R, et al. Elucidating Proteoform Families from Proteoform Intact-Mass and Lysine-Count Measurements. J Proteome Res. 2016; 15(4):1213-1221; Ho B, et al. Unification of Protein Abundance Datasets Yields a Quantitative Saccharomyces cerevisiae Proteome. Cell Syst. 2018; 6(2):192-205.e3). Approximately 92% of the estimated 5,858 different proteins have been identified and quantified. A wide dynamic abundance range is observed, spanning from 50 to 100000 molecules per cell for various proteins. The abundance of the low-level protein ranges from 3 to 822 molecules per cell, while each of the high-abundant yeast proteins features more than 10,000 molecules per cell. One particular study using a top-down mass spectrometry approach revealed 8,637 unique proteoforms of the yeast proteome, including those of 60S ribosomal L12-A, Histone H2B.1, and 60S ribosomal L40. The ability of the disclosed analytical platform to detect various proteoforms with highly similar sequences and structures can be exemplified by separating and identifying diverse proteoforms of 60S ribosomal L12-A present in the yeast proteome.

The intact, native-like structures of proteoforms can be evaluated by the mass and the cross-section. The subunit arrangement can then be investigated using collision-induced dissociation at elevated gas pressure in Tandem-TIMS. Additionally, the MS3-based top-down workflow by collision-induced dissociation and UV photodissociation can be used in combination with parallel accumulation serial fragmentation (PASEF) to identify the primary structure of distinct proteoforms. The wealth of structural information obtained by Tandem-TIMS can enable the accurate identification of proteoforms with similar sequences and posttranslational modifications.

### Example 2. Profiling and Characterization of Low-Abundant Plasma Proteoforms

Various proteoforms of Interleukin-6 (IL-6) in the plasma of healthy donors can also be evaluated. Interleukin-6 (IL-6) is a low-abundant plasma protein (5 pg/mL) associated with inflammation and cardiovascular diseases (Ridker P M, et al. Plasma Concentration of Interleukin-6 and the Risk of Future Myocardial Infarction Among Apparently Healthy Men. Circulation. 2000; 101(15):1767-1772) with two types of posttranslational modifications: glycosylation and phosphorylation (May L T, et al. Marked cell-type-specific differences in glycosylation of human interleukin-6. Cytokine. 1991; 3(3):204-211).

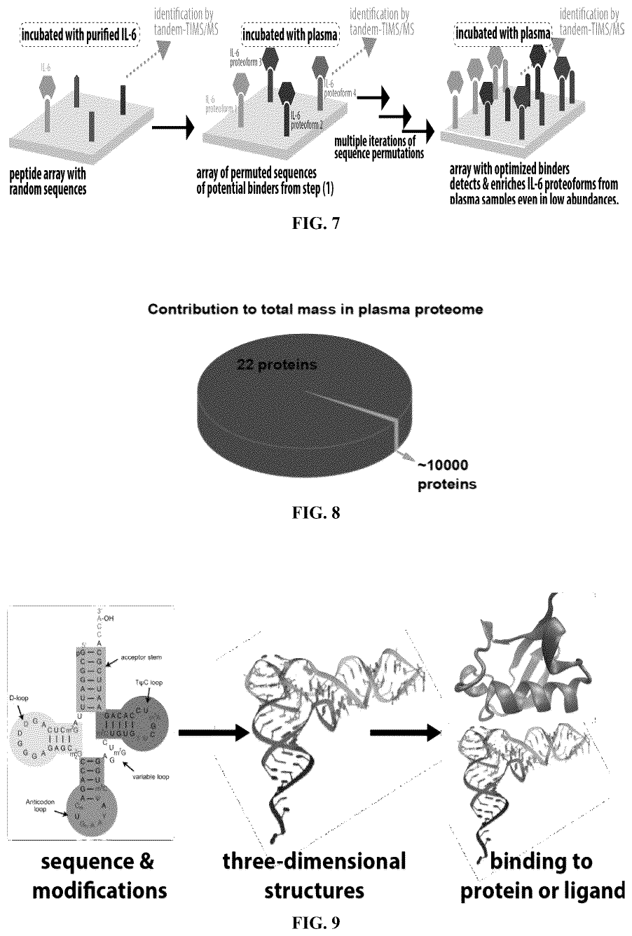

Purified Interleukin-6 (IL-6) and combinatorially synthesized peptide microarray can be used to screen for peptide sequences that bind to IL-6. Once the peptide sequences have been determined, they can be used to initiate optimization for peptide binders that target specific low-abundant IL-6 proteoforms in plasma (see also FIG. 7). These peptide binders can be generated in a sizable format, allowing only the low-abundant IL-6 proteoforms to be enriched on the microarray prior to ionization and transfer to the Tandem-TIMS instrument for identification.

### Example 3. Characterization of Structures and Binding Affinity of Low-Abundant Plasma Proteoforms

The interaction between immunoglobulin G (IgG) and Fcγ receptors is a crucial aspect of the immune system. Distinct proteoforms of IgG antibodies exhibit varying binding affinities towards Fcγ immune cell receptors, thereby triggering positive and negative immune responses. Perturbation of a well-balanced immune response can result in aberrant responses causing diseases. Therefore, the identification of various IgG proteoforms in plasma and the characterization of binding between IgG proteoforms and Fcγ-receptors are of immense importance in understanding the mechanisms underlying health and diseases. The disclosed analytical platform (FIG. 2) can be used to separate and identify various IgG proteoforms in plasma, including low-abundant proteoforms. The binding affinity and specificity of various IgG proteoforms in plasma toward FcγRIIIB receptor can be investigated by the integrated LSPR biosensor. Utilizing Tandem-TIMS coupled to MS/MS, the structures of various IgG proteoforms-FcγRIIIB receptor complexes can be characterized.

FcγRIIIB receptors can be immobilized on microarrays to capture various IgG proteoforms present in plasma. Using Nano-DESI, the intact, native complexes of various IgG proteoform-FcγRIIIB receptor complexes can be ionized and transferred into the Tandem-TIMS instrument. Utilizing the diverse analysis workflows in Tandem-TIMS structural characterization of the IgG proteoform-FcγRIIIB receptor complexes can be achieved. The LSPR biosensor integrated into the microarray's solid support can be employed to determine the binding affinity and specificity of distinct IgG proteoforms towards the FcγRIIIB receptor.

### Example 4. Structural and Functional Analysis of RNA

Approximately 85% of the human proteome is undruggable; these proteins possess flat functional interfaces that lack a hydrophobic pocket structure suitable for ligand binding (Martinsen E, et al. Advances in RNA therapeutics for modulation of ‘undruggable’ targets. in Progress in Molecular Biology and Translational Science vol. 204 249-294 (Elsevier, Amsterdam, Boston, 2024). RNA-based therapeutics are a highly promising approach to treat or prevent various diseases associated with undruggable proteins by altering the gene expression and, subsequently, the produced proteins in target cells (Roundtree I A, et al. Dynamic RNA Modifications in Gene Expression Regulation. Cell. 2017; 169:1187-1200).

Ribonucleic acids (RNA) can be classified into messenger RNA (mRNA) and non-coding RNAs (ncRNAs). The cellular function of mRNA is to convey genetic information by forming a template to synthesize proteins in ribosomes. Non-coding RNAs are functional RNAs that are not translated into proteins, which include transfer RNA (tRNA), ribosomal RNA (rRNA), microRNA, and many others (Passmore L A, et al. Roles of mRNA poly(A) tails in regulation of eukaryotic gene expression. Nat Rev Mol Cell Biol. 2022; 23:93-106). Both coding and non-coding RNAs can undergo various chemical modifications post-transcriptionally, substantially impacting their structure and biological function. Poly(A) modifications at the 3′ end control translation initiation and enhance mRNA stability (Dominissini D, et al. The dynamic N1-methyladenosine methylome in eukaryotic messenger RNA. Nature. 2016; 530:441-446), while methylation at the N1 position of adenosine modulates the translation and can impact the RNA-protein interactions (Li X, et al. Transcriptome-wide mapping reveals reversible and dynamic N1-methyladenosine methylome. Nat Chem Biol. 2016; 12:311-316; Zhang W, et al. tRNA modification dynamics from individual organisms to metaepitranscriptomics of microbiomes. Mol Cell. 2022; 82:891-906). Further, eukaryotic tRNA modifications correlate with coding efficiency, folding, stability, and localization (Hentze MW, et al. A brave new world of RNA-binding proteins. Nat Rev Mol Cell Biol. 2018; 19:327-341). These examples illustrate how post-transcriptional modifications in RNAs regulate various cellular, developmental, and disease processes. Further, many RNAs form assemblies with proteins or small molecule ligands to perform cellular functions (Van Nostrand E L, et al. A large-scale binding and functional map of human RNA-binding proteins. Nature. 2020; 583:711-719; Jiang J, et al. Post-transcriptional Modifications Modulate rRNA Structure and Ligand Interactions. Acc Chem Res. 2016; 49:893-901). These complexes play important roles in gene expression regulation and are implicated in various diseases, including cancer, neurodegenerative disorders, and viral infections. The protein/ligand binding often favors unique conformational states, which are induced by post-transcriptional modifications in RNA molecules (Helm M, et al. Posttranscriptional RNA Modifications: Playing Metabolic Games in a Cell's Chemical Legoland. Chem Biol. 2014; 21:174-185). As such, understanding how post-transcriptional modifications alter the three-dimensional structures of RNA and stabilize certain conformation states that promote protein/ligand binding is crucial in designing novel RNA therapeutics interventions.

The disclosed analytical approach can be used to understand how post-transcriptional modifications in RNAs stabilize specific local/global conformations, which, in turn, influence the protein/ligand binding (FIG. 9). The correlation between post-transcriptional modifications and the three-dimensional structures of RNA, and how this relationship modulates the complex formation, can be probed by employing the disclosed analytical platform (FIG. 2). The native top-down analysis workflow in Tandem-TIMS/tandem-MS can be used to elucidate the RNA structures, and the microarray to isolate/enrich RNA molecules of interest from a complex sample.

Transfer RNA (tRNA), known for exhibiting the largest chemical diversity and complexity in its post-transcriptional modification, can be investigated (Huang T-Y, et al. Top-down tandem mass spectrometry of tRNA via ion trap collision-induced dissociation. J Am Soc Mass Spectrom. 2010; 21:890-898). The limited size (˜25 kDa) and relatively short sequence (74-95 nucleotides) renders Saccharomyces cerevisiae (yeast) tRNA a good model system for testing the disclosed analytical platform (Lanzillotti M B, et al. A High-Throughput Workflow for Mass Spectrometry Analysis of Nucleic Acids by Nanoflow Desalting. Anal Chem. 2024; doi:10.1021/acs.analchem.3c05428; Bou-Nader C, et al. Conformational Stability Adaptation of a Double-Stranded RNA-Binding Domain to Transfer RNA Ligand. Biochemistry. 2019; 58:2463-2473). The disclosed analytical approach can also be used to investigate larger non-coding RNAs.

A hybrid tandem-ion mobility/microarray platform developed can be used to explore the dsRBD/tRNA complex in human tRNA-dihydrouridine synthase 2. The double-stranded RNA binding domain (dsRBD) is present in many RNA-maturing enzymes involved in various cellular processes. Conformational changes induced by post-transcriptional modifications in various tRNAs and how these changes alter the interactions with the main binding domain of dsRBD can be investigated.

Other advantages, which are obvious and which are inherent to the invention, will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

1. A method for analyzing ions comprising:
providing ions from an ion source to a first trapped-ion mobility spectrometry analyzer, wherein the ion source is a peptide or RNA microarray;
separating the ions according to mobility in the first trapped ion mobility spectrometry analyzer;
selecting precursor ions of at least one limited mobility range;
fragmenting the selected precursor ions into fragment ions;
trapping the fragment ions in a second trapped ion mobility spectrometry analyzer;
separating the fragment ions according to mobility in the second trapped ion mobility spectrometry analyzer; and
detecting the separated fragment ions.

2. The method of claim 1, wherein the microarray is a combinatorially generated array of peptides that bind to an array of target molecules.

3. The method of claim 1, wherein the target molecules comprise distinct proteoforms of a target peptide.

4. The method of claim 1, wherein the microarray is a plasmonic peptide microarray.

5. The method of claim 1, wherein the ions are provided from the ion source by nano-desorption electrospray ionization.

6. The method of claim 1, wherein steps of separating ions in the first trapped-ion mobility spectrometry analyzer, selecting precursor ions, and fragmenting the selected precursor ions are repeated while the second trapped-ion mobility spectrometry analyzer is operated to accumulate the repeatedly fragmented ions prior to separating them according to mobility.

7. The method of claim 1, wherein the selected precursor ions are fragmented between the first and the second trapped-ion mobility spectrometry analyzer.

8. The method of claim 7, wherein the selected precursor ions are fragmented by collision induced dissociation or UV photodissociation which results from accelerating the selected precursor ions in or into a gas filled region by applying electric DC potentials to at least two annular electrodes which are located between the first and the second trapped-ion mobility spectrometry analyzer.

9. The method of claim 1, wherein the selected precursor ions are fragmented inside the second trapped-ion mobility spectrometry analyzer.

10. The method of claim 9, wherein the selected precursor ions are pushed by a gas flow against a rising edge of an electric DC field barrier of the second trapped-ion mobility spectrometry analyzer and photons are introduced at the rising edge for inducing photo-dissociation of the selected ions in the second trapped-ion mobility spectrometry analyzer.

11. The method of claim 9, wherein the selected precursor ions are pushed by a gas flow against a rising edge of an electric DC field barrier of the second trapped-ion mobility spectrometry analyzer and ETD reactant ions or highly excited or radical neutral particles are introduced upstream of the rising edge for inducing electron transfer dissociation of the selected ions in the second trapped-ion mobility spectrometry analyzer or fragmentation of the selected ions by reactions with the highly excited or radical neutrals in the second trapped-ion mobility spectrometry analyzer.

12. The method of claim 1, wherein the ions from the ion source are separated according to mobility in time in the first trapped-ion mobility spectrometry analyzer and the ions of the limited mobility range are selected by adjusting the transmission of an ion gate which is located between the first and the second trapped-ion mobility spectrometry analyzer.

13. The method of claim 1, wherein the ions from the ion source are trapped and separated according to mobility in space in the first trapped-ion mobility spectrometry analyzer, and the ions of the limited mobility range is selected by adjusting an instrumental parameter of the first trapped-ion mobility spectrometry analyzer or by changing the mobility of ions of the limited mobility range such that the ions of the limited mobility range leave the first trapped-ion mobility spectrometry analyzer while other trapped ions stay trapped in the first trapped-ion mobility spectrometry analyzer.

14. The method of claim 1, wherein the trapping time of the selected precursor ions prior to fragmentation is varied in subsequent measurements in order to determine the mobility of fragment ions as a function of time.

15. The method of claim 1, wherein the selected precursor ions are activated prior to the fragmentation and/or the fragment ions are activated prior to the separation in the second trapped-ion mobility spectrometry analyzer.

16. The method of claim 15, wherein activation energy introduced into the selected precursor ions and/or fragment ions is varied in order to determine the mobility of the fragment ions as a function of the activation energy.

17. The method of claim 1, wherein the fragment ions are further analyzed by acquiring mass spectra or acquiring fragment mass spectra.

18. A method for analyzing ions comprising:
providing ions from an ion source to a first trapped-ion mobility spectrometry analyzer, wherein the ion source is a peptide or RNA microarray;
separating the ions according to mobility in the first trapped-ion mobility spectrometry analyzer;
selecting ions of a limited mobility range;
activating or reacting the selected ions;
trapping the activated or reacted ions in a second trapped-ion mobility spectrometry analyzer;
separating the trapped ions according to mobility in the second trapped-ion mobility spectrometry analyzer; and
detecting the separated ions.

19-25. (canceled)

26. An ion mobility spectrometer comprising an peptide or RNA microarray as an ion source, a first trapped-ion mobility spectrometry analyzer, a second trapped-ion mobility spectrometry analyzer located downstream of the first trapped-ion mobility spectrometry analyzer, a fragmentation cell or reaction cell, which is located between the first and the second trapped-ion mobility spectrometry analyzer or is part of the second trapped-ion mobility spectrometry analyzer, and an ion detector.

27. The ion mobility spectrometer of claim 26, wherein the microarray is a plasmonic peptide microarray.

28-31. (canceled)
